(19) United States
(12) Patent Application Publication
(10) Pub. No.: US 2006/0265592 A1
(43) Pub. Date: Nov. 23, 2006

(54) Television broadcast receiver and television broadcast receiving method

(76) Inventors: Masaki Tsuchida, Ome-shi (JP); Noriya Sakamoto, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/411,863

(22) Filed: Apr. 27, 2006

(30) Foreign Application Priority Data
Apr. 28, 2005 (JP) 2005-132054

(51) Int. Cl. H04L 9/00

(52) U.S. Cl. 713/176

(57) ABSTRACT

Copyright protection for a broadcast signal, personally acquired content or personal information can be easily achieved. For such an object, a digital television broadcast receiver having a print data output unit comprises a specification information detection unit 56k1 to detect whether or not specification information is added to input content, a proper information discrimination unit 56k2 to discriminate whether or not the detected specification information is proper information, and a print output control unit 56k4 to set the print data output unit in an operation allowed sate when the specification information is the proper information and to set the print data output unit in an operation disallowed state when the specification information is not the proper information.

### CROSS-REFERENCE TO RELATED APPLICATIONS

This application is based upon and claims the benefit of priority from Japanese Patent Application No. 2005-132054, filed Apr. 28, 2005, the entire contents of which are incorporated herein by reference.

### BACKGROUND

1. Field

One embodiments of the invention relate to a television broadcast receiver and a television broadcast receiving method. More specifically, the embodiment of the invention relates to a device having a function to prevent a broadcast signal from being printed out illegally in a device having a printer connection function.

2. Description of the Related Art

In recent years, an information recording medium such as a hard disk and an optical disk as a recording medium has been increased in its storage capacity. Therefore, a method and a device for automatically recording a desired program on the recording medium by connecting a recording/reproducing device using the information recording medium to, for example, a television receiver have been available. In general, program recording reservation information is prepared by using electronic program guide (EPG) information so as to realize an automatic recording function and an automatic recording/reproducing device. It has been taken into consideration for a device to automatically set the recording reservation information by automatically retrieving a program that corresponds to a desired category from the EPG information when the desired category is specified.

A device capable of connecting a printer thereto and printing a part of contents has been developed in a television broadcast receiver or digital recording equipment (refer to prior patent documents of Japanese applications, for example, Jpn. Pat. Appln. KOKAI Publication No. 2002-369091, Jpn. Pat. Appln. KOKAI Publication No. 2001-218138, Jpn. Pat. Appln. KOKAI Publication No. 2004-306323, and Jpn. Pat. Appln. KOKAI Publication No. 2004-265216).

In the case of printing of the part of the contents, it is necessary to pay attention to copyright violation such as unlimited copying. However, measures taken to protect copyright are insufficient. The digital recording device has a function to manage the copyright; however the function is one to move a content to a recording medium (a content of a movement-source is deleted), and a measure against printing is insufficient. Systems for managing copyright have been documented (refer to, for example, Japanese patent applications, Jpn. Pat. Appln. KOKAI Publication No. 2004-265216 and Jpn. Pat. Appln. KOKAI Publishing No. 2003-022377). However, it is not clear from these techniques how to combine copyright management with a printout function.

As mentioned above, a printer has become connectable to the digital recording device or the broadcast receiver; however sufficient measures for copyright protection of a broadcasted content are not taken. It is considered that a plurality of persons share the recording/reproducing device in the digital broadcast receiver allowing a plurality of recording-reproducing devices to be connected thereto. In this case, it is a current state that the measure against the copyright protection for a printout of content owned personally is taken no account of.

### SUMMARY

According to one embodiment of the invention, it can obtain copyright protection for a broadcast signal easily and surely and also can take the copyright protection against a content obtained personally or personal information.

A digital television broadcast receiver having a print data output unit comprises a specification information detection unit which detects whether or not specification information is added to an input content; a discrimination unit which discriminates whether or not the specification information detected by the specification information detection unit is prescribed proper information, and a printout control unit which sets the print data output unit in an operation allowed state when the identified information from the discrimination unit is identified that the specification information is the proper information, and otherwise stated, sets the print data output unit in an operation disallowed state.

Accordingly, the foregoing television broadcast receiver can prevent the broadcast signal from being output because of absence of the specification information and can protect copyright of a personal video for personal video data by setting the specification information in the personally owned video data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a television broadcast receiver regarding an embodiment of the invention;

FIG. 2 is an exemplary view showing a television broadcast receiver regarding other embodiment of the invention;

FIG. 3 is an exemplary view showing a television broadcast receiver regarding different embodiment of the invention;

FIG. 4 is an exemplary view moreover showing a television broadcast receiver regarding further different embodiment of the invention;

FIG. 5 is an exemplary view showing a television broadcast receiver regarding a different embodiment of the invention;

FIG. 6 is an exemplary flowchart showing an operation example of a television broadcast receiver regarding the embodiment;

FIG. 7 is an exemplary view schematically showing an example of a television broadcast receiver to which the invention is adopted and a network system around the broadcast receiver;

FIG. 8 is an exemplary view showing an external appearance of the above-mentioned broadcast receiver;

FIG. 9 is an exemplary view showing a principal signal processing system of a digital television broadcast receiver 101 regarding the embodiment;

FIG. 10 is an exemplary view showing an external appearance of a remote controller 17;

FIG. 11 is an exemplary view showing an inner function of an inside of a control unit 56 in further detail; and

FIG. 12 is an exemplary view showing a configuration of a video camera regarding the embodiment.

### DETAILED DESCRIPTION

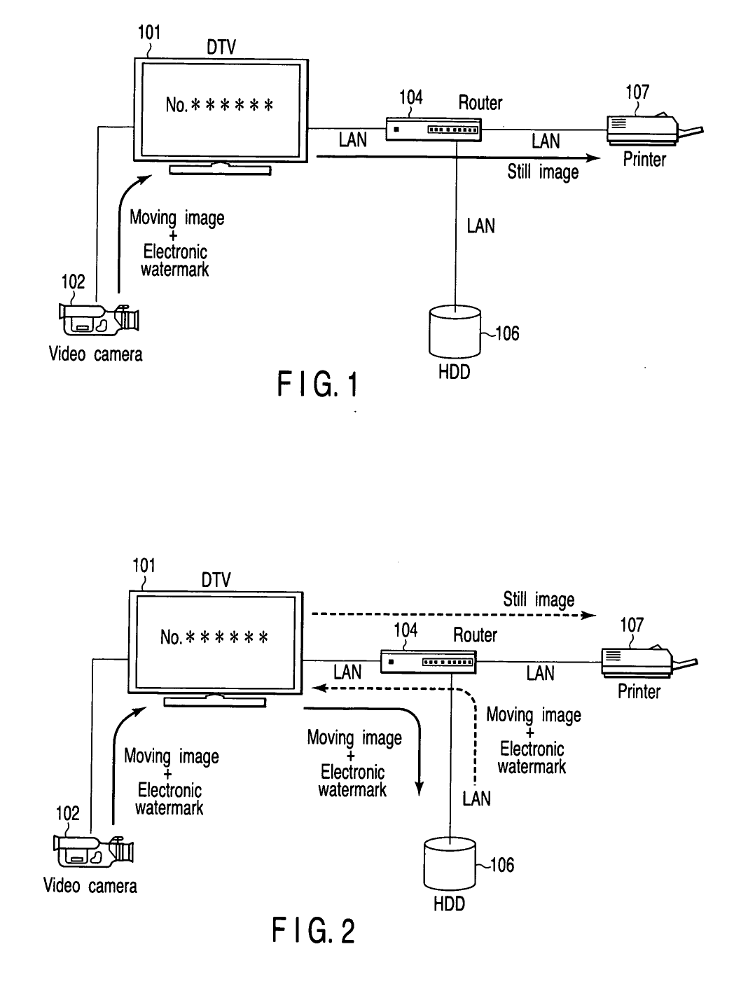

Hereinafter, embodiments of the present invention will be explained by referring the drawings. At first, a basic configuration and a plurality of embodiments will be explained with reference to FIGS. 1 to 5.

FIG. 1 shows an embodiment. A video recording device (video camera) is connected to a network-compatible digital television receiver (DTV) 101 through a communication cable [for example, local area network (LAN) or universal serial bus (USB)]. Further, the DTV 101 is connected to a relay such as a router 104 or a HUB. The router 104 is connected to an external HDD 106 and a printer 107 through the LAN.

The video camera 102 is a video device capable of adding an electronic watermark to a video signal so that a user proves the fact that the video is photographed by itself in a position to protect copyright in a photographing operation. At this moment, the electronic watermark in a moving image is a name or a serial number of equipment now being used for photographing, or a value itself freely input by the user (so-called key information), or its converted information. The converted information is formed on the basis of a prescribed rule.

Here, in the case of a free input, the video camera 102 itself inquires, before starting photographing, whether or not the user freely inputs the key information so as to obtain the electronic watermark. When inputting the key information, the user operates an input operation part of the video camera 102. In the case of an electronic watermark other than the above-described electronic watermark, it is assumed that automatically created key information is registered in the video camera 102.

Thereby, the user adds an electronic watermark to a personally photographed video by using the video camera 102. The video photographed by the video camera 102 is input to the DTV 101 through the communication cable to be displayed on a display device.

On this occasion, the user cannot recognize the electronic watermark by eye. Then, the DTV 101 confirms whether or not the electronic watermark is present in the photographed video. If present, the DTV 101 checks whether or not the electronic watermark is one added by proper equipment. In such a method, the DTV 101 acquires the key information through existing data in the inside of the DTV 101 or through the Internet to reproduce or delete information on the electronic watermark included in the video signal, based on the acquired key information. If the information of the electronic watermark is reproduced or deleted, the corresponding device is a proper one. If the key information has been freely input, in a stage of printing a still image, the user inputs key information (value), similar to the freely input key information, again on the DTV 101 (or the user may input the key information in advance) to check the electronic watermark. As a result, if the electronic watermark is one added by the proper equipment, in other words, if the electronic watermark is a correct one, the DTV 101 permits printing. Or, the key information may be input in advance.

As the result of checking of the electronic watermark, if it is determined that a still image being a part of a moving image is proper, the DTV 101 transmits still image data to a printer 107 through a LAN to print it. Otherwise stated, the DTV 101 prevents the still image data from being transmitted to the printer 107. In this case, an alarm sound is output or an alarm image is displayed.

As mentioned above, by structuring a system that makes it possible to determine whether or not the still image in the moving image to be targeted has been photographed by the user itself, the still image data not permitted to be printed, such as a broadcast wave, is prevented from being printed without permission.

Accordingly, the user can avoid the problem of copyright and freely enjoy personal content. By having a means for adapting a function to insert the electronic watermark into a video recording device (video camera or the like) in advance to determine whether or not the electronic watermark is proper by the DTV 101, a burden determination is not necessary for the printer side or the user itself to additionally determine whether or not the printing should be permitted.

FIG. 2 is an exemplary view showing an operation when a content including an electronic watermark and being photographed by the video camera 102 is stored in the external HDD 106 through the router 104. Having described an example to print out the video from the video camera 102 by the printer 107 through the DTV 101 in the above-mentioned embodiment; however, the video from the video camera 102 may be stored once in the HDD 106 sometimes. The video then may be read out from the HDD 106 to be printed out.

Even when a video signal is stored in the HDD 106, the video signal is stored in a state that the electronic watermark is added thereto similarly. The video signal can be reproduced and displayed by the DTV 101, and in this case, the electronic watermark is read to be checked. Here, if the content is one acquired by the user itself by using the video camera 102, the content becomes possible to be printed at any time. The other operations are the same as those of the aforementioned example.

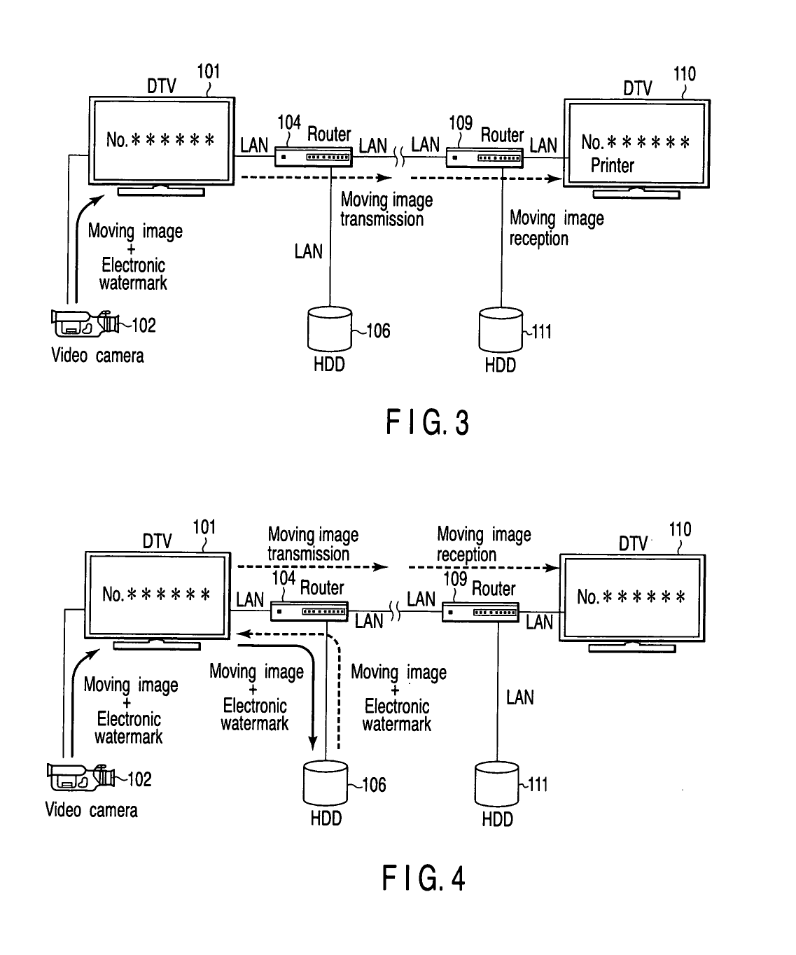

FIG. 3 shows a different embodiment of the invention. FIG. 3 shows an example of a system connected to a network-compatible DTV 110 outside the home through the Internet from a network to which the network-compatible DTV 101 and the video recording device (video camera 102) are connected.

The parts as in the foregoing embodiment are assigned similar reference numerals to be described. The router 104 is connected to another home use router 109 through the Internet. The network-compatible DTV 110, an external HDD 111 and the like are connected to the router 109.

The relationship among the video camera 102, the electronic watermark, the DTV 101 and the HDD 106 has been described already. Now, when it is determined that a moving image to be transmitted is proper, based on the electronic watermark, the system can transmit the moving image to the network-compatible DTV 110 through the LAN and the Internet. Here, the DTV 110 having received the moving image checks information of the electronic watermark by using key information (letter or name of equipment registered in advance or referred on the Internet). If the electronic watermark has been prepared freely by key input, the system prompts the user to input letters or the like, which become the key information, through an operation unit of the DTV 110.

Thereby, the electronic watermark can assume a role of a key on the side of the external DTV 110. When it is determined that the targeted moving image is proper, the external DTV 110 reproduces the moving image transmitted for the first time. Otherwise stated, the DTV 110 is set so that it cannot reproduce the transmitted moving image.

According to the above-mentioned embodiment, when acquiring content from the external DTV 101 through the router 109, the DTV 110 checks the electronic watermark to determine whether or not the content has been allowed to be displayed.

As mentioned above, according to the embodiment, the system can determine whether or not the targeted content is the moving image photographed by the user itself. Thereby, the system can prevent the moving image, which has not been permitted to be transmitted, such as a content created by recording once a broadcast wave onto a recording medium and reproducing it from being transmitted/received.

Therefore, the system can protect the copyright of the broadcast signal. On the other hand, the user can enjoy the content of the user itself by transmitting/receiving it freely among the members of family and friends. By having a means for adding an electronic watermark to a video recording device (video came or the like) in advance and for determining whether or not the electronic watermark is proper by means of a DTV, the electronic watermark serves as a substitute of a key and the system can view and record the content without any regard for the problem of the copyright.

FIG. 4 shows another embodiment of the invention. Having described the example to transmit the video from the video camera 102 to the DTV 110 in the embodiment in FIG. 3, but it is possible, as shown in FIG. 4, for the video from the video camera 102 to be stored in the HDD 106, the video from the video camera 102 may be read out from the HDD 106 transmitted, as content with the electronic watermark added thereto, to the network-compatible DTV 110 set outside the home. The moving image stored in a state in which the electronic watermark is added can be reproduced and displayed at any time by the DTV 101. And at that time, the electronic watermark is read out and checked, then if the content is own content of the user itself, it can be transmitted to the network-compatible DTV 110 set outside the home at any time. The other operations are the same as those of the former embodiment.

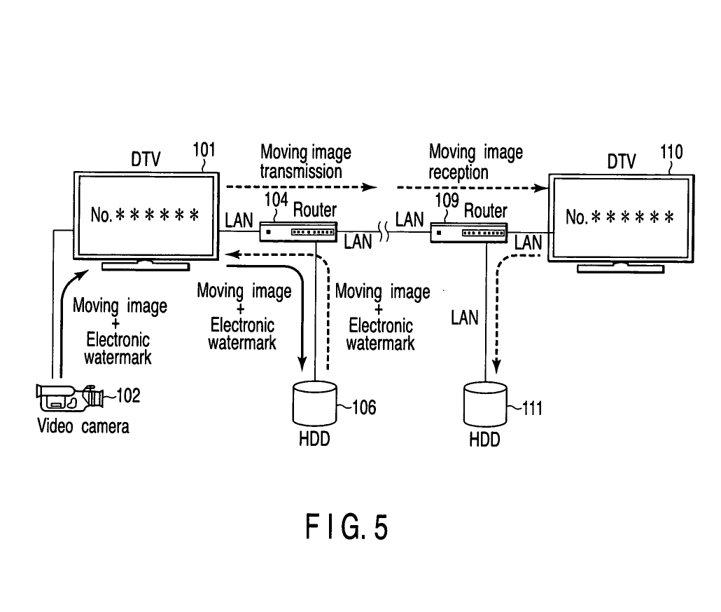

FIG. 5 shows a further embodiment of the invention. In this embodiment shown in FIG. 5, the DTV 101 can reproduce to display at any time the moving image stored in a state in which the electronic watermark is added and simultaneously read out to check the electronic watermark. Accordingly, the DTV 110 may transmit the content to the network-compatible DTV 110 outside home at any time if the electronic watermark is owned by the user itself. Furthermore, if it is determined that the received moving image is proper, the system can only display it on the DTV 110 but also record to store it on the external HDD 111 and the like through the router 109. The other operations are the same as those of the former embodiment.

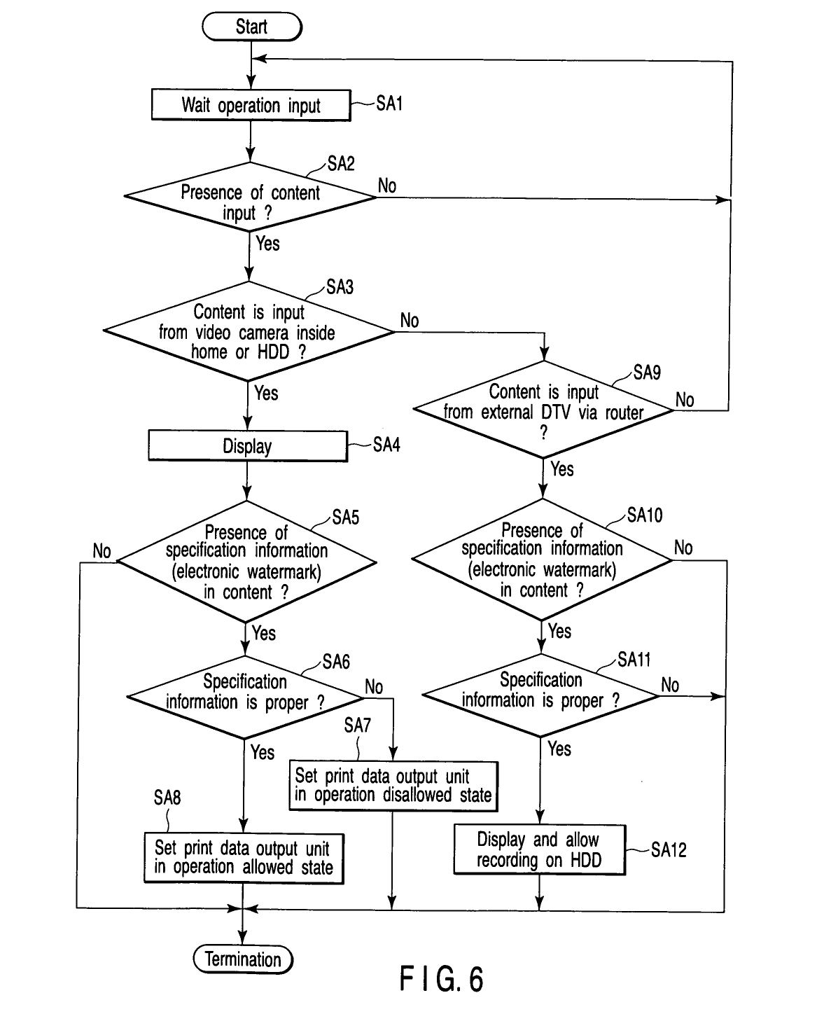

FIG. 6 is an exemplary flowchart for explaining an operation example of control units in the above-mentioned digital television receivers 101 and 110. In particular, the operations related to the present invention will be explained. As described above, the control units detect whether or not inputs of contents from the video camera 102 or HDD 106 are present (blocks SA1 and SA2). If the inputs of the contents are present, the control units detect whether or not the contents have been input from the video camera 102 or the HDD 106. This detection is conducted by, for example, analyzing header information or the like in a communication format (IEEE 1394). However, the receiver of the present invention is not limited to be utilized in the foregoing determination method; the receiver may select the method to be adopted thereto among a variety of determination methods. As described in FIG. 1 and FIG. 2, the control units display the contents, if the contents have been input from the video camera 102 or the HDD 106 (block SA4) and discriminate whether or not specification information (electronic watermarks) is (are) added to the contents (videos) (block SA5).

If the electronic watermarks are added in the contents, the control units determine whether or not the electronic watermarks are proper (block SA6) to display the videos. If they are proper, the control units permit operations of print data output units (block SA8), and if they are not proper, the control units set the print data output units in an operation disallowed state (block SA7), and then terminate the processing.

In the foregoing block SA3, if the contents have not been input form the video camera 102 or the HDD 106, the control units determine whether or not the contents have been input from the outside through the router 109 (block SA9) (examples in FIG. 3 and FIG. 4). If the contents have been input from the outside, the control units determine whether or not the specification information (electronic watermarks) is (are) added to the contents (block SA10). If the specification information has been added to the contents and if they are proper (block SA11), the control units display the contents on the display unit for the first time. And the control units also allow the HDD 111 to record the contents thereon.

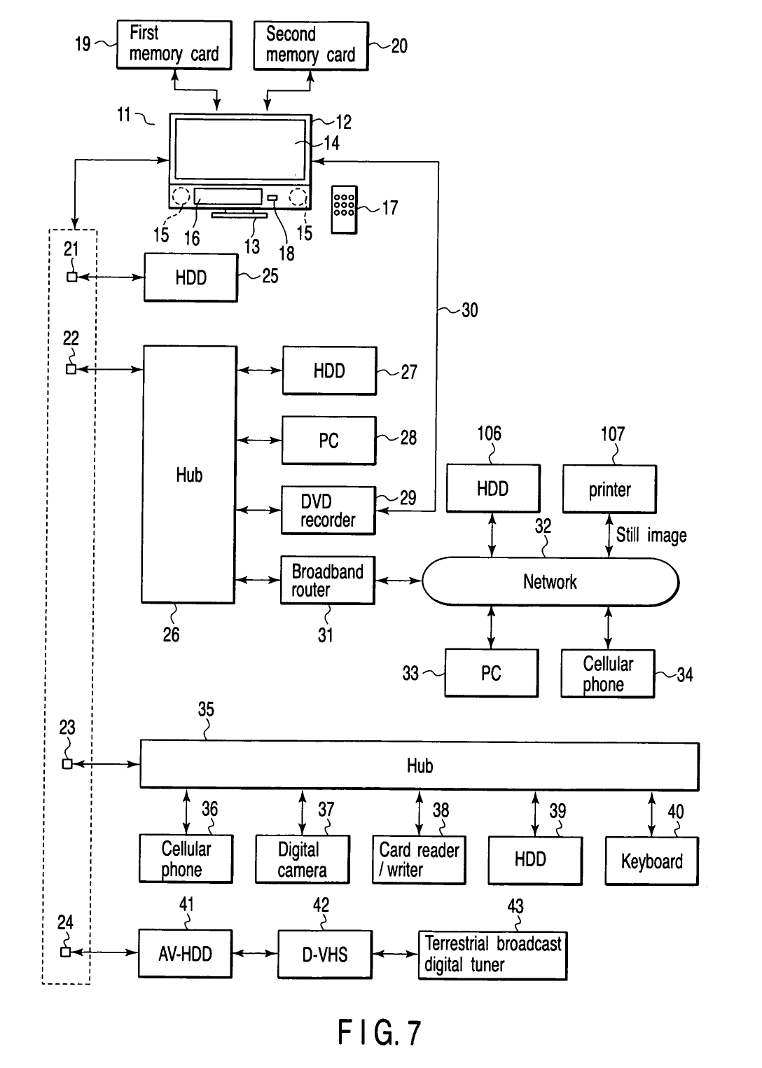

FIG. 7 is the exemplary view schematically showing the example of the television broadcast receiver to which the invention is adopted and of the network system around the broadcast receiver.

The digital broadcast receiver 11 is composed mainly of a thin cabinet 12 and a support base 13 making the cabinet 12 raised and supported. The cabinet 12 is provided with, for example, a flat panel type video display unit 14 composed of a liquid crystal display panel or the like, a loudspeaker 15, an operation unit 16, and a light receiving unit 18 to receive operation information transmitted from a remote controller 17.

The broadcast receiver 11 is adapted to receive a first detachable memory card 19 such as a secure digital (SD) memory card, a multimedia card (MMC) or a memory stick, and performs recording/reproducing of information of, for example, about such as a program or a photograph to and from the first memory card 19.

The broadcast receiver 11 is further adapted to receive a second detachable memory card (IC card) 20 with, for example, contract information recorded thereon, and performs recording/reproducing of information to and from the second memory card 20.

The broadcast receiver 11 is provided with a first local area network (LAN) terminal 21, a second LAN terminal 22, a universal serial bus (USB) terminal 23 and an i.Link terminal 24.

Among these parts, the first LAN terminal 21 is used as a LAN-compatible HDD dedicated port. The first LAN terminal 21 is connected to a LAN-compatible HDD 25 being a network attached storage (NAS). The first LAN terminal 21 is used to record/reproduce information through a network (e.g., Ethernet network).

As mentioned above, by providing the first LAN terminal 21 to be the LAN-compatible HDD dedicated port, the broadcast receiver 101 can record a program with a high image quality to the HDD 25 without being influenced by another network environment or the status of use of the network.

The second LAN terminal 22 is used as a general LAN-compatible port using Ethernet. The second LAN terminal 22 is connected to equipment, for example, a LAN-compatible HDD port 27, personal computer (PC) 28, and a digital versatile disk (DVD) recorder 29 with a built-in HDD through a hub 26 and is used to make information transmissions between the equipment and the broadcast receiver 11.

Since digital information communicated through the second LAN terminal 22 is control information, the DVD recorder 29 utilizes a dedicated analog transmission path 30 to transmit analog information of video and sound to the broadcast receiver 11.

The second LAN terminal 22 is connected to, for example, a network 32 such as the Internet via a broadband router 31 connected to the hub 26 and used to communicate information between a PC 33, a cellular phone 34 or the like, and the broadcast receiver 11 via the network 32. The above-mentioned HDD 106 and the printer 107 are connected to the second LAN terminal through the network 32. And the second LAN terminal 22 is also connected to other DTVS (DTVS 110 in FIG. 3-FIG. 5).

The aforementioned USB terminal 23 is used as a general USB-compatible port, connected to, for example, a cellular phone 36, a digital camera 37, a card reader/writer 38 for a memory card, an HDD 39, or a keyboard 40. The USB terminal 23 is used to make information transmissions between the equipment and the broadcast receiver 11.

The foregoing i.Link terminal 24 serially connects an AV-HDD 41, a digital (D)-video home system (VHS) 42, etc. and supports information transmissions between the equipment and the broadcast receiver 11.

Here, the AV-HDD 41 connected to the i.Link terminal 24 is shown outside the broadcast receiver 101 in FIG. 1; however, it is actually incorporated in the support base 13. That is, the AV-HDD 41 is integrated with the broadcast receiver 11.

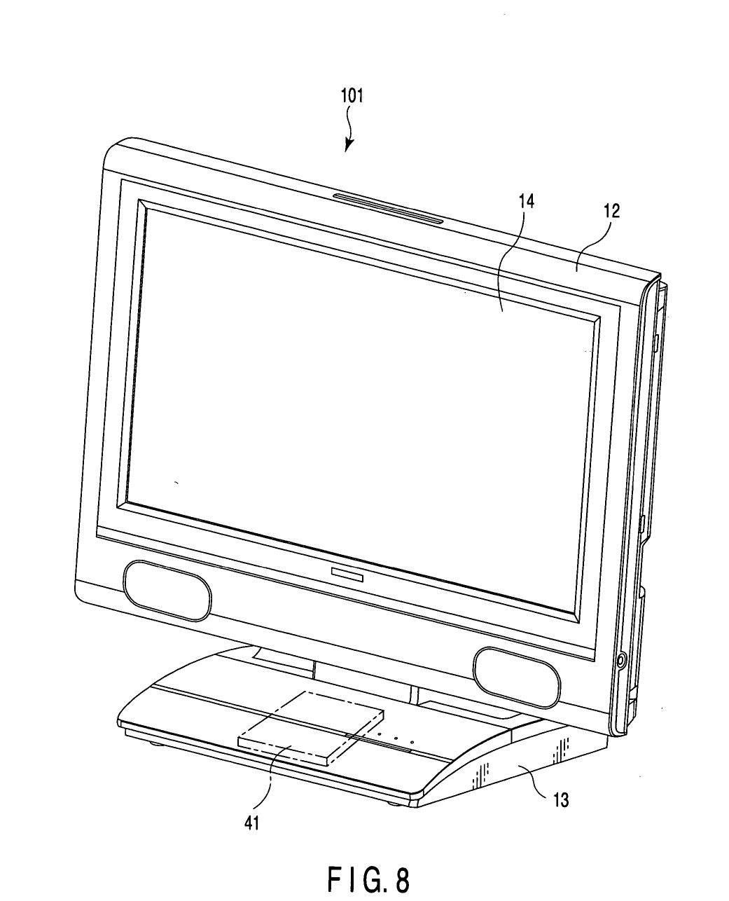

FIG. 8 shows the external view of the foregoing broadcast receiver 101. The AV-HDD 41 is incorporated in the support base 13.

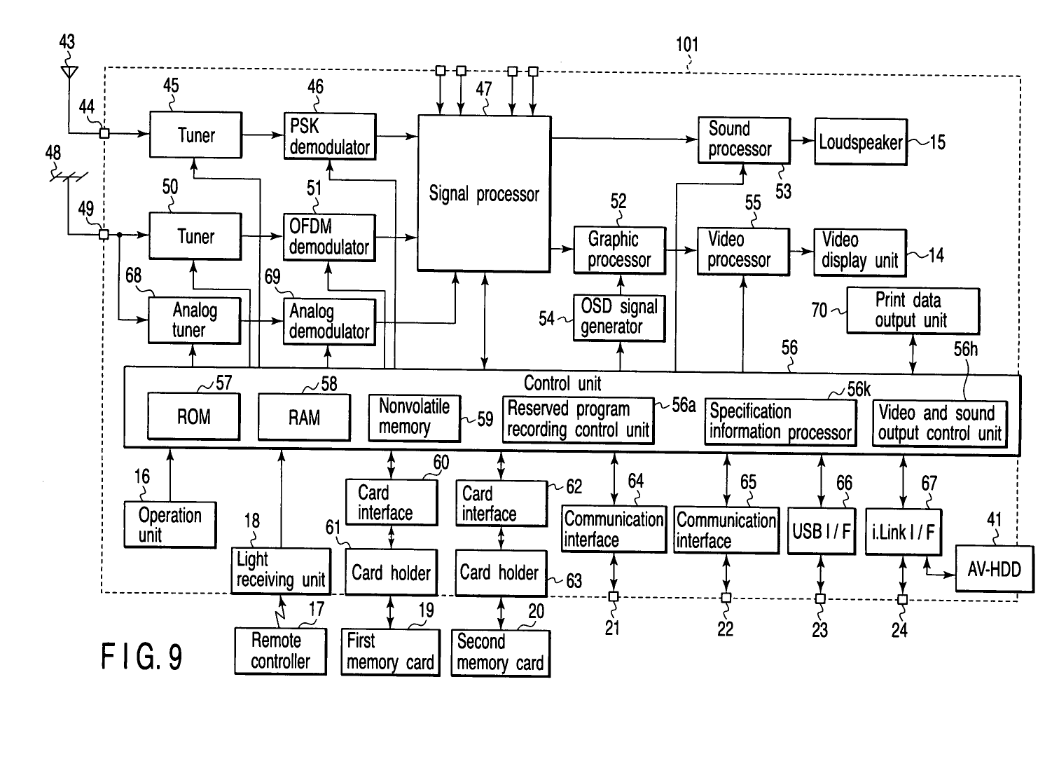

FIG. 9 shows the principle signal processing series of the foregoing broadcast receiver 101. That is, a satellite digital television broadcast signal, received at an antenna 43 for receiving a BS/CS digital broadcast, is supplied to a tuner 45 for satellite digital broadcast through an input terminal 44, and the tuner 45 tunes a broadcast signal of a desired channel.

The broadcast signal tuned by the tuner 45 is fed to a phase shift keying (PSK) demodulator 46 to be demodulated to a digital video signal and a digital sound signal, which are output to a signal processor 47.

The broadcast receiver 101 also has an analog tuner 68 for receiving a terrestrial analog signal. An analog demodulator 69 demodulates the signal received by the analog tuner 68 to output it to the signal processor 47.

A terrestrial digital television broadcast signal, received at a second antenna 48 for receiving a terrestrial digital broadcast, is supplied to a tuner 50 for the terrestrial digital television broadcast via an input terminal 49. The tuner 50 tunes the broadcast signal of the desired channel.

The broadcast signal tuned by the tuner 50 is supplied to an orthogonal frequency division multiplexing (OFDM) demodulator 51 to be demodulated to a digital video signal and a digital sound signal, then output to the signal processor 47.

The signal processor 47 selectively conducts prescribed digital signal processing of the digital video signals and sound signals supplied from the PSK demodulator 46 and from the OFDM demodulator 51. The signal processor 47 selectively conducts the prescribed digital signal processing of the video signals and sound signals supplied from the analog demodulator 69 and further from the line input terminals. The signal processor 47 outputs output signals to a graphics processor 52 and a sound processor 53.

Among the processors, the graphics processor 52 has a function to superimpose an on-screen display (OSD) signal generated from an OSD signal generator 54 on the digital video signal supplied from the signal processor 47 to output the superimposed signal. The graphics processor 52 can selectively output the video signal output from the signal processor 47 and the OSD signal output from the signal generator 54 and also combine to output both outputs so that both outputs configure a half of a screen, respectively.

The digital video signal output from the graphics processor 52 is supplied to a video processor 55. The video processor 55 converts the input digital video signal into an analog video signal in a format possible to be displayed on the video display unit 14 and outputs the analog video signal to the video display unit 14 to produce a video display.

The sound processor 53 converts an analog sound signal in a format that can be reproduced by the loudspeaker 15 and outputs the analog sound signal to the loudspeaker 15 to make a sound reproduction.

Here, a control unit 56 integrally controls all operations, including the foregoing various types of receiving operations of the broadcast receiver 101.

As further shown in FIG. 9, the broadcast receiver 101 further comprises the control unit 56. The control unit 56 has a built-in central processing unit (CPU), which receives operation information from the operation unit 16, or receives operation information transmitted from the remote controller 17 and respectively controls each part so as to reflect operation contents thereto.

In this case, the control unit 56 mainly uses a read only memory (ROM) 57 with a control program to be executed by the CPU stored thereon, a random access memory (RAM) 58 to provide an operation area to the CPU, and a nonvolatile memory 59 to which a variety of items of setting information and control information are stored.

The control unit 56 is connected to a card holder 61 to which the first memory card 19 can be attached through a card interface 60. The control unit 56 is adapted to support the exchange of information transmissions with the first memory card 19 attached to the card holder 61 through the card interface 60.

The control unit 56 is further connected to a card holder 63 to which the second memory card 20 can be attached through a card interface 62. The control unit 56 thereby can communicate information with the second memory card 20 attached to the card holder 63 through the card interface 62.

The control unit 56 is also connected to the first LAN terminal 21 through a communication interface 64. The control unit 56 thereby can communicate with the LAN-compatible HDD 25 connected to the first LAN terminal 21 through the communication interface 64. In this case, the control unit 56 has a dynamic host configuration protocol (DHCP) server function and assigns an Internet protocol (IP) address to the LAN-compatible HDD 25 connected to the first LAN terminal 21 to control the HDD 25.

The control unit 56 is further connected to the second LAN terminal 22 through a communication interface 65. The control unit 56 thereby can communicate with any equipment (refer to FIG. 1) connected to the second LAN terminal 22 through the communication interface 65.

The control unit 56 is further connected to the USB terminal 23 through a USB interface 66. The control unit 56 thereby can communicate with any equipment (refer to FIG. 1) connected to the USB terminal 23 through the USB interface 66.

Furthermore, the control unit 56 is connected to the i.Link (registered trademark) terminal 24 through an i.Link (registered trademark) interface 67. Thereby, the control unit 56 can communicate with any equipment (refer to FIG. 1) connected to the i.Link (registered trademark) terminal 24 through the i.Link (registered trademark) interface 67.

The control unit 56 furthermore includes a reserved program recording control unit 56a to reserve a recording program in advance to record it in a recording medium, a specification information processor 56k and video and sound output control unit 56h. The specification information processor 56k performs the above-mentioned operations described in FIG. 6.

Furthermore, the broadcast receiver 101 is provided with a print data output unit 70 controlled by the control unit 56. The print data output unit 70 outputs data to the above-described printer 107.

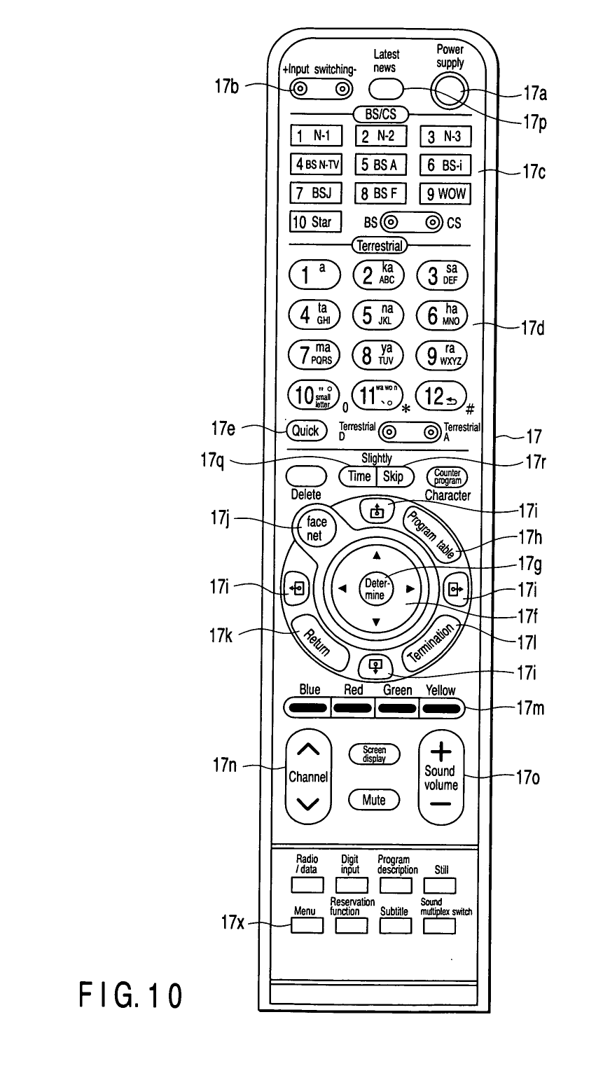

FIG. 10 shows the external view of the remote controller 17. The remote controller 17 mainly comprises a power key 17a, input switching keys 17b, direct tuning keys 17c for satellite digital broadcast channels, direct tuning keys 17d for terrestrial broadcast channels, a quick key 17e, a cursor key 17f, a determination key 17g, a program table key 17h, page switching keys 17i, a face net (registered trademark) (navigation) key 17j, a return key 17k, a terminate key 17l, color keys in blue, red, green and yellow 17m, a channel up and down key 17n, a sound volume adjusting key 17o, etc. Furthermore, the remote controller 17 has a “least news” key 17p, a “Slightly time” key 17q and a “Slightly skip” key 17r.

When a menu key 17x is pressed, a guide screen to perform a printout is displayed. When selecting an item to perform the printout, the user can view, for example, a preview of a moving image on a sub-screen. If the preview shows a preview image to be printed, a still image is displayed by pressing the determination key 17g. It is also possible to perform frame feeding of the image forward or backward from a still image state. When a desired still image is displayed, if the user selects a key to determine the printing by the cursor key 17f and presses the determination key 17g, the printing is started. However, as described above, a video image can be printed only under the condition that the electronic watermark added to the video image is proper.

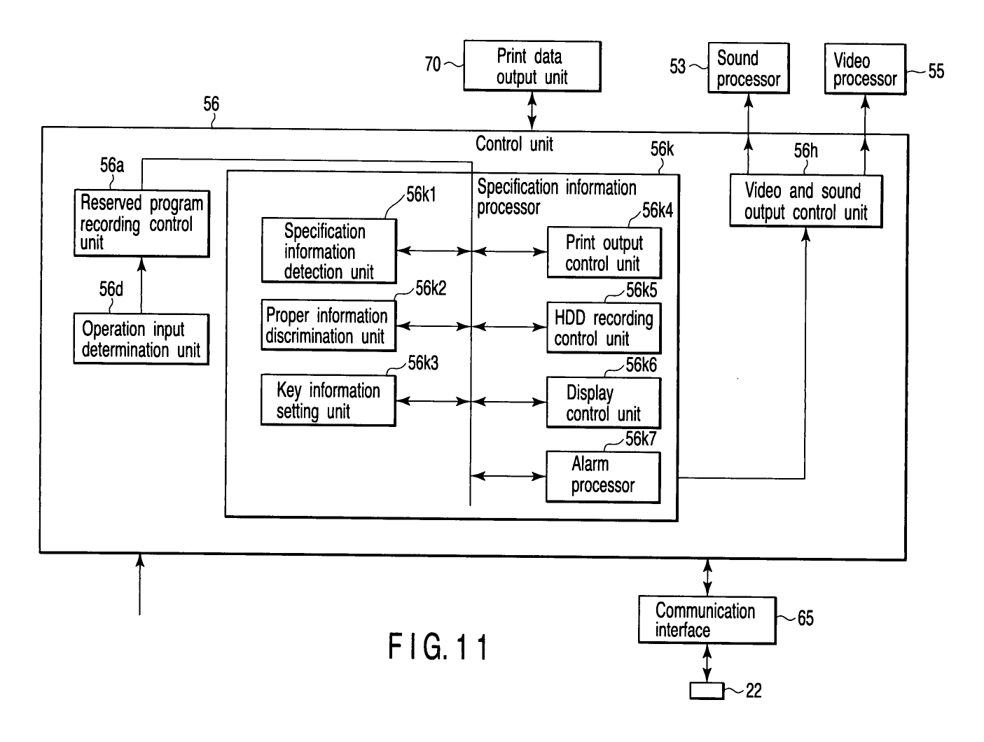

FIG. 11 shows the details of the functions of the inside of the foregoing control unit 56. A specification information processor 56k of the control unit 56 has a specification information detection unit 56k1 to detect whether or not the electronic watermark is added to the video signal. The specification information processor 56k has a proper information discrimination unit 56k2 to discriminate whether or not the electronic watermark is input from proper equipment, as described above. The specification information detection unit 56k also includes a key information setting unit 56k3 to store information used for the electronic watermark such as an equipment ID, an equipment serial number or an equipment name. The specification information detection unit 56k further includes a print output control unit 56k4 to control (to set operation permission and operation inhabitation) of a print output control unit 56k4. The specification information detection unit 56k further includes an HDD recording control unit 56k5 to be operated when the content with the electronic watermark added thereto is recorded to the HDD. The specification information detection unit 56k moreover includes a display control unit 56k6 (for processing blocks SA4 and SA12 in FIG. 6) and an alarm processor 56k7. The alarm processor 56k7 produces a tone when the user tries to print out an image prohibited to be printed out.

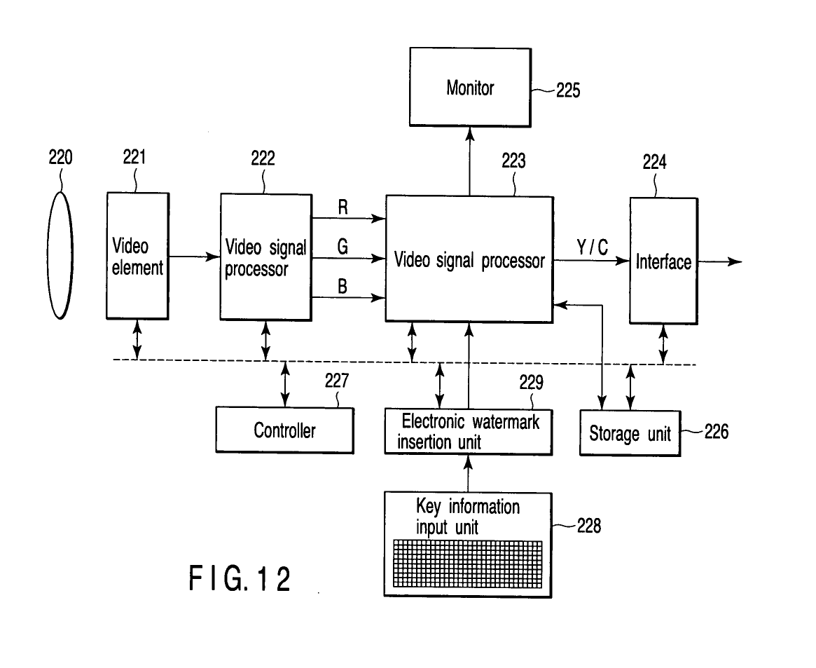

FIG. 12 shows an example of a configuration of the video camera 102. An optical image from an optical system 220 is converted into an electric signal and input to an image signal processor 222. The image signal processor 222 separates a video signal into RGB signals to supply them to a video signal processor 223. The video signal processor 223 can perform processing such as amplification and white balance and color adjustment to convert the RGB video signals into a Y/C signal and output it outside through an interface 224. The video signal processor 223 also can output the RGB signals to a monitor 225 to produce a video display. Furthermore, the video signal processor 223 can record the RGB video signals to a storage unit 226 and also can read out the recorded video signals to output them outside.

Here, the video camera 102 has a function to add the electronic watermark to the video signals in photographing processing. An electronic watermark insertion unit 229 is a circuit to add the electronic watermark. In the case of the free input, the user can input the key information to the equipment though the key information input unit 228 of the operation unit 16 shown in FIG. 9.

As mentioned above, according to the present invention, the broadcast receiver can perform a printout processing, HDD recording and the like for a video signal with the electronic watermark added thereto as long as the electronic watermark can be confirmed. Thereby, it is prevented for the broadcast video signal which is fundamentally forbidden to be printed from being printed without permission. That is to say, the broadcast receiver can contribute to the copyright protection. Having described an example to add the electric watermark to the video signal, the video signal may be encrypted with the key information. Further, even in the case of supplying of the video signal to the display unit, the video may be scrambled and brought into a non-viewable state.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital television broadcast receiver, having a print data output unit, comprising:
a specification information detection unit (56k1) which detects whether or not specification information is added to input content;
a discrimination unit (56k2) which discriminates whether or not the specification information detected by the specification information detection unit is prescribed proper information; and
a print output control unit (56k4) which sets the print data output unit in an operation allowed state when discrimination information from the discrimination unit indicates that the specification information is the proper information and sets the print data output unit in an operation disallowed state when the discrimination information from the discrimination unit indicates that the specification information is not proper information.

2. The digital television broadcast receiver according to claim 1, wherein the discrimination unit has a key information setting unit (56k3) which sets key information so as to discriminate the specification information.

3. The digital television broadcast receiver according to claim 2, wherein the key information setting unit is configured to receive an input from a manual input or a communication cable.

4. The digital television broadcast receiver according to claim 3, wherein the key information of the key information setting unit includes either an equipment name or an equipment serial number.

5. The digital television broadcast receiver according to claim 3, wherein the key information of the key information setting unit is freely input information.

6. The digital television broadcast receiver according to claim 1, wherein the specification information detection unit is configured to acquire the content from an externally connected video camera or a hard disk device integrated with a main body of the broadcast receiver.

7. The digital television broadcast receiver according to claim 6, further comprising:
a HDD recording control unit configured to record an input from the video camera onto the hard disk device and record a video with an electronic watermark added thereto.

8. The digital television broadcast receiver according to claim 1, further comprising:
a display control unit which enables display-outputting to a display unit when the discrimination information from the discrimination unit indicates that the specification information is proper information and disables display-outputting to the display unit when the discrimination information from the discrimination unit indicates that the specification information is not proper information.

9. The digital television broadcast receiver according to claim 5, wherein the video camera has an electronic watermark insertion unit which adds an electronic watermark to a video signal.

10. A digital television broadcast receiving method having a control unit to control operations, receiving a broadcast signal by a receiving unit on the basis of the control by the control unit, demodulating and signal-processing the received signal by a demodulator and signal processor to convert it into a display signal, and storing the display signal onto a recording medium in response to an operation input, the method further comprising:
detecting whether or not specification information is added to input content;
discriminating whether or not the detected specification information is prescribed proper information;
setting a print data output unit in an operation allowed state when discrimination information from the discrimination unit indicates that the specification information is proper information; and
setting the print data output unit in an operation disallowed state when the discrimination information from the discrimination unit indicates that the specification information is not proper information.

11. The digital television broadcast receiver according to claim 10, further comprising:
discriminating whether or not the detected specification information is proper information in a state of displaying input content if the input content is input from a video camera connected to a broadcast receiver main body or from a hard disk device;
discriminating whether or not the specification information is added to the input content if the input content is transferred through a router and whether or not the specification information is proper information if the specification information is added to the input content; and
displaying the content when it is determined that the specification information is the proper information.
